(19) United States
(12) Patent Application Publication
(10) Pub. No.: US 2006/0137253 A1
(43) Pub. Date: Jun. 29, 2006

(54) Method for making a mobile window pane for a vehicle and window pane mobile in height for vehicle

(75) Inventors: Rolf Kotte, Alsdorf (DE); Karl Hartl, Graz (AT)

Correspondence Address: OBLON, SPIVAK, MCCLELLAND, MAIER & NEUSTADT, P.C., 1940 DUKE STREET, ALEXANDRIA, VA, 22314, US

(73) Assignee: SAINT-GOBAIN GLASS FRANCE, COURBEVOIE (FR)

(21) Appl. No.: 10/524,671

(22) PCT Filed: Aug. 13, 2003
(86) PCT No.: PCT/FR03/02535

§ 371 Date: Sep. 12, 2005

(30) Foreign Application Priority Data
Aug. 17, 2002 (DE) 102 37 756.1

(51) Int. Cl. E05F 11/38

(52) U.S. Cl. 49/375

(57) ABSTRACT

A method for fabrication of a vehicle drop glass, with a transparent, in particular curved, pane, on the extremity of which a support part is to be attached, which cooperates with a drive and/or guide device for heightwise movement of the pane. In the method the pane is oriented and attached at plural predetermined points of its surface in a device adapted to its shape, a curable plastic material is deposited on the pane with aid of at least one tool in the region of the assembly with the support part and is fashioned, in a fixed position in the space inside the device, into a fashioned part which, after its assembly with the pane, defines the position of the support part in relation to the predetermined points. The plastic material is then cured. A window pane can be produced according to the method.

The present invention concerns a method for the fabrication of a vehicle drop glass, in particular for a vehicle door without frame, with transparent pane, on the extremity of which a support part can be attached or is attached, which cooperates with a drive and/or guide device for the heightwise movement of the pane. The invention also relates to such a drop glass for a vehicle.

Vehicle drop glasses of the abovementioned type, which are incorporated into doors that have no frame or no guide above the extremity of the door, and which, as a result, are guided only by an appropriate mechanism inside the body of the door, are used mainly in sports cars, coupes or cabriolets. The pane must, when closed, engage exactly into the upper seal or be pressed firmly against the latter. The seals may be in the form of a channel and surround the pane on both sides, but most frequently a flat seal is provided only on one side, against which seal the pane must press with sufficient pressure the full length of the extremity (closure edge) of its main face in question. However, if the positioning is not sufficiently precise in the panels closed position, difficulties may arise with respect to closing the door or the window or there may be defects of sealing. On the one hand, the pane may in particular warp or on the other hand a gap may appear between the seal and the edge of the window.

Usually, for such vehicle drop glasses, use is made of curved and toughened panes of which certain flexing tolerances, imposed by fabrication, that is differences in relation to its ideal window shape, must be accepted. It is only with as precise an alignment as possible between the pane guide remaining inside the body of the door and the pane that the inevitable flexing tolerances of the pane can be compensated for and the desired sealing can be assured.

Through German patent application DE 44 35 008 A1, an adjustment device is known for a motor vehicle door window pane cooperating with a pane lifting device, preferably formed or guided without frame, which comprises at least one vertical guide rail guiding the pane lifting device, placed inside the body of the door, in which the guide rail can pivot in the transverse direction of the vehicle around an upper rotation point and can be immobilized in a predetermined position by an adjustment device attached in the lower region of the guide rail. The adjustment device can be accessed through the lower face of the door body such that an adjustment of the door glass is possible without dismantling the door lining.

Through document DE 199 43 619 A1, there is a known device for moving the pane of a vehicle door without frame, in which a drive unit is adjustable in a vertical guide rail. The pane is linked to the drive unit. For the adjustment of the initial pressure with which the pane is applied against the rubber seal of the vehicle door opening, it can pivot in a transverse plane of the vehicle. As such, its lower edge is coupled to an adjustment bolt passing vertically through the drive unit, the coupling extremity of which is eccentric relative to the adjustment bolt's axis of rotation and which moves the pane by causing the adjustment bolt to turn in the transverse direction. The adjustment bolt may be actuated through an opening in the lower face of the door.

The known solutions in respect of the adjustment of vehicle drop glasses relative to the door seal, in particular in the upper region of the door, have the disadvantage that they actuate relatively complicated devices, which provoke a transverse tilting of the pane. Furthermore, several adjustment tests are usually required in order to obtain the desired effect, because the adjustment operation is carried out when the window is down. It is then not possible to ascertain immediately whether the adjustment operation has succeeded, because the window must again be returned to its up position to verify it.

Document DE 196 27 398 A1 describes a vehicle drop glass with a support part of the type mentioned in the introduction which consists of a polymer withstanding a mechanical force and preferably bonded directly to the pane, in which is provided, between the support part and its articulation on the lifting mechanism, an intermediate elastic part intended to compensate for the assembly and fabrication tolerances. This description does not however address the problem of the bearing of the window against the seal in the closed position.

Furthermore it is also known (DE 41 23 256 C1, DE 198 37 348 A1), particularly when shaping plastic extremity seals on window panes for vehicle, to form or fashion the plastic parts in situ with the aid of automatic tools linked to the device.

The present invention seeks to ensure that vehicle window panes solidly attached to the support part press firmly in a reliable manner against their seals in the closed position, and that the lifting mechanism with the support part attached to it can be placed inside the door body without major adjustment work, in a reproducible assembly position with small dimensional differences in the context of production-line manufacture.

A vehicle window pane within the meaning of the invention should be understood to be a glass or plastic substrate as well as a laminate of glass and/or plastic substrates. Usually, such laminates are produced by assembling together several solid substrates with an adhesive thermoplastic sheet in between. There may however also be a single solid substrate assembled to a functional sheet or a functional sheet added in the laminate.

The invention now aims to present the method for the fabrication of a vehicle drop glass which, when closed, can press firmly against its seal without complicated adjustment operations and/or devices and with the desired initial pressure. It will also be appropriate to propose corresponding vehicle drop glasses for frameless vehicle doors.

According to the invention, this problem is solved by the features of method claim 1 as well as the associated product claim 7. The respective secondary claims contain other features which supplement the invention advantageously.

According to the invention, the dimensional differences due to the curvature of the pane inside the interface or the region of assembly between the support part and the pane are compensated for. The pane is assembled to the support part, or is fitted in the latter such that the latter can on the one hand be assembled without difficulty into the lift mechanism preassembled into the door body, and on the other hand bring the pane reliably into its closed position.

This compensation for the tolerances is obtained, according to the invention, with the aid of a fashioned part, which is formed in situ on the pane attached with the aid of several predetermined surface points in a spatial position independent of the real position and configuration of the pane in the assembly region; it thus presents a configuration individually adapted to each pane.

In even more precise terms, said points of the pane surface are placed on fixed contact points of a device or of a template adapted to each window form, said fashioned part then being produced for the attachment of the support part with the aid of at least one appropriate tool in a spatial position and orientation clearly defined in relation to the contact points, that is to say that it is always in the same position inside the device or in the system of coordinates of the latter.

Depending on the application, different tools may be envisaged for the positioning of the plastic and for the fashioning of the mass, in which operations the fashioning tool must in each case ensure the highly precise positioning of the fashioned part or of its contact faces for the support part. However, it is also possible to envisage there being only one tool for both the positioning and the fashioning of the plastic mass.

Said device or template must be considered to be a 1:1 model of the assembly space (vehicle door) with which the real window closure position can be simulated and its assembly with the support part guided in its movement with extremely tight tolerances in the vehicle door can be carried out correctly for each individual pane. Thus it can be certain that the support part is capable of guiding the pane towards the seal, in all cases correctly positioned in its closed position in the actual door. In total, a precise alignment of the upper edge of the pane is obtained relative to the weather seal of the bodywork as early as during assembly with the guide or drive unit. The latter no longer needs to be provided with adjustment devices. Naturally, the abovementioned dimensional differences of the panes must lie within certain admissible limits so that all the panes can be fabricated with limit values that are admissible by a single device.

When applying the method according to the invention, the pane is placed in the device in such a manner that it lies on several, preferably on three, points of one of its main faces, while its face, or its peripheral edge, is placed against fixed stops. In the real assembly position, the abovementioned contact points correspond to points of contact of the pane with the vehicle door or the bodywork. After attachment of the pane, the fashioned part can be formed by depositing in the region of placement of the support part on the pane surface a curable plastic material in pasty form, which is then shaped with the desired superficial structure with the aid of a goffering or forming tool.

If two of the (three) predetermined points lie in the region of the upper edge of the pane, or of its sealing edge, therefore in the important region for the pressing of the pane against the “window” seal of the bodywork, and if the third point lies near the support part, the lateral tilt of the pane and the position of the upper edge of the pane in relation to the support part are predetermined. The points represent a reference plane, which is independent of the curved structure of the pane between these points. With such a pane, the orientation of the support part is in particular independent of the local curvature of the pane (end tangent) in the region of the support part.

The position as well as the final position of the face of the forming tool coming into contact with the plastic are naturally aligned in relation to the predetermined points as a function of the coordinates of assembly in the corresponding door. This alignment is achieved in a particularly simple and effective way, when the forming tool and the contact points for the pane are disposed on a single appropriate device.

The aligned fashioned part is preferably made of a material that can undergo plastic deformation, for example a polymer. This polymer may be a pasty plastic which is fashioned according to the desired position orientation and which is then cured. If using a plastic material with two or more components, it cures after a certain reaction time. Plastics which react with the humidity of the air or which cure under the influence of electromagnetic radiation, for example ultraviolet radiation, may also be used.

It is also possible to use thermoplastic-deformation plastic materials that are heated for forming and have a stable form after they have cooled. Their softening temperatures must of course be higher than the temperatures reached during operation of the vehicle.

After the plastic has cured, the fashioned part is prepared for the remainder of the assembly.

In principle, it would be possible, with the method according to the invention, to produce for each pane a fashioned part individually suited to its curvature, which does not bond to the pane and which serves as a free “intermediate layer” for a subsequent assembly common with the support part. In preference, the support part however bonds directly with the pane in such a way as to constitute a unit comprising the pane and the support part. According to an advantageous variant, it constitutes on the pane a reference or contact face correctly oriented in the region of assembly between the pane and the support part, which cooperates with a corresponding opposite face of the support part.

The vehicle drop glass according to the invention is characterized in that the support part solidly assembled to the pane, which cooperates with the drive and/or guide device or which forms a part of it, is already aligned in a defined manner in relation to several determined points, in preference three determined points of the pane surface, before it is assembled to the drive and/or guide device inside the vehicle door.

The contact face of the fashioned part may possess a surface of flat, cylindrical or spherically curved shape or be provided with determined structures. Naturally, flat contact faces are particularly simple to produce. In all cases, the contact face and the opposite contact face of the support part must correspond to one another as precisely as possible in order to obtain a good fit without play.

If the support part is to be used as an assembly element with two clamping jaws for a coupling of the pane with the drive or guide device, it may be worthwhile to envisage support parts, or contact faces oriented in accordance with the invention, on the front surface and on the rear surface of the pane in the region of the clamping jaws of the support part. Assembly of the assembly element is then particularly simple, because the individual parts have to be placed only on the prepared contact faces and cannot become deformed in relation to one another. Since the intercalated fashioned part, specific to the pane, corresponds exactly to the shape, respectively to the structure of the pane, in the region of assembly, relatively high clamping forces can be applied to the pane without having to employ an elastic intermediate layer or without even deforming the pane.

The support part, which is made for example of a metal or of a hard plastic, must naturally be assembled in an appropriate fashion to the contact face or to the pane, for example by means of a bonded assembly. Another, non-adhesive, assembly between the support part and the fashioned part may be achieved by furnishing the support parts coming into contact with the contact faces with a projecting threaded stud or an internal threaded bore. Any other type of known option may also be envisaged; besides an assembly using clamps or clips, mention can also be made of screwing directly into the material of the contact face. A particularly simple method of assembly may be obtained when the pane and the contact face are provided with a bore hole through which a bolt with or without thread is passed. If the support part is formed all in one piece, it must also be provided with an appropriate bore hole through which the bolt then also passes.

If, for the contact face, a plastic material is used which can bond both with the support part and with the pane, a complete module consisting of the pane with a contact face and a support part can then be fabricated in the device; this dispenses with the later additional operations of attaching the support part. In this case, for the fabrication of the vehicle drop glass, use is made of a device with a forming tool which can receive the support part and place it directly in its definitive position on the deposited plastic material still pasty, or sticky.

According to a variant of the latter, the support part is first placed in its definitive position in relation to the pane and the intermediate space remaining between the face or the body of the pane and the support part is then filled with the plastic material in order to produce the fashioned part. In this particular instance, the support part is in fact a portion of the mold intended for the fashioned part.

Naturally, bonding and mechanical means of assembly between the support part, the pane and the fashioned part can also be combined.

When the plastic material has cured, the pane and the support part form a unit in which the fashioned part specific to the pane is inserted as a linkage or adapter part.

Yet another method for the fabrication of a vehicle window pane according to the invention consists in producing the fashioned part itself directly as at least one essential component of the support part or as the support part in its entirety, the pane again being oriented in an appropriate device with the aid of predetermined points on its main face. However, instead of depositing a uniform mass of plastic on the pane and of fashioning it into a contact face with an adapter, the support part is in this case directly formed on the pane. In other words, the support part is positioned as one part in a spatial position fixed by the device on the fixed pane. The forming tool necessary for this is again naturally aligned toward the abovementioned points, in such a way that the support part including the contact face is fabricated in a single piece and independently of the curved plot in the zone of contact with the pane. Here also, the forming tool is in preference coupled directly with the device or with the orientation template.

In all these variants, the assembly between the support part and the pane is sufficiently solid to be able to transmit a certain initial pressure of the pane onto the lateral guide faces and the seals of the pane, which is introduced by the support part, or the lift mechanism.

Among the methods for fabricating such fashioned parts, mention can be made per se of the injection methods, such as for example the injection molding method, and the extrusion method with a forming bench or later forming. It should be noted that the fashioned part is not visible in the assembled state, so while admittedly it must comply with the dimensions, does not absolutely have to comply with severe esthetic criteria.

Other details and advantages of the object of the invention will be revealed in the drawings of an exemplary embodiment and in their detailed description which follows.

In the simplified representations that are not to any particular scale,

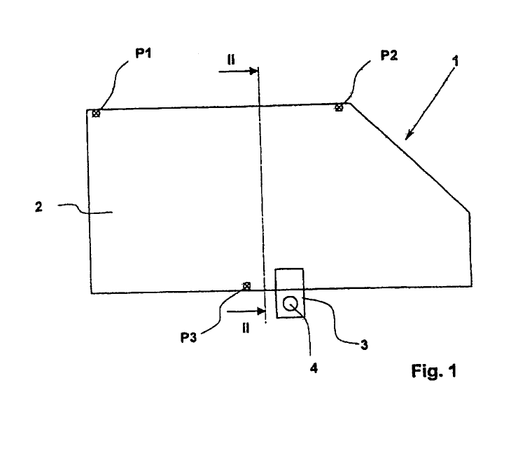

FIG. 1 shows a vehicle drop glass with a support part fixed to it; and

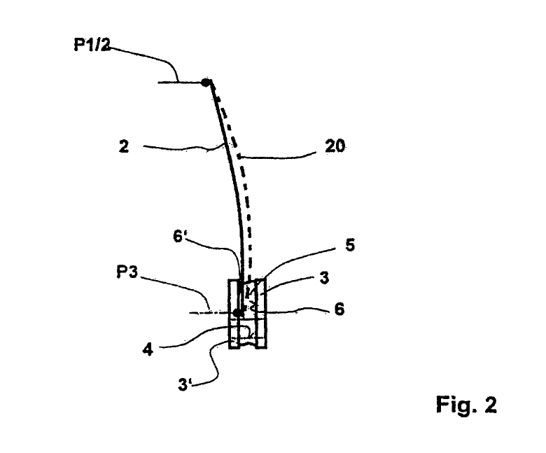

FIG. 2 illustrates a view section of this same vehicle pane along line II-II of FIG. 1.

According to FIG. 1, a vehicle window pane 1 serving as a drop glass for a motor vehicle (in the driver or passenger door) consists of a transparent glass pane 2, cylindrically curved in the plane of the drawing, and a support part 3 fixed to the lower extremity of this pane, which is furnished with a through hole 4. The latter is intended to receive a bolt or screw with which the vehicle pane 1 is assembled to a lift mechanism. The bolt, or the screw and the lift mechanism are not shown here for the sake of simplicity; also not shown are the other assembly elements situated around the vehicle pane.

On the surface (with concave curvature) of the glass window 2 facing toward the interior of the vehicle there are three predetermined points P1, P2 and P3 on which the support part 3 is aligned in a defined manner as has been described hereinabove. The points P1 and P2 are disposed on the upper edge (sealing edge) of the glass window 2, the point P3 is on the lower edge of the glass window 2 close to the support part 3.

The shortest lateral edge (on the right) of the glass window 2 of trapezium shape is, faces the assembled position, toward an A-pillar of a vehicle, the longest lateral edge (on the left) faces toward a B-pillar. Usually, the panes are still guided at least on one side (on the interior main face) by sealing beads, in the door's closed position. The support part and the lift mechanism exert a certain initial static pressure through the glass window 2 onto these guide and sealing beads.

FIG. 2 shows that a fashioned part 5 is disposed close to the point P3 (indicated by a chain line) in the region of the support part 3, on the main face of the glass window 2 facing toward the exterior of the vehicle and exhibiting a uniaxial convex curvature, between the latter and the support part 3. The fashioned part 5 consists of a plastic material, preferably a thermoplastic, and it is fashioned directly onto the glass window 2, but it also extends beyond the extremity of the latter. If required, an appropriate primer is first applied to the surface of the pane in order to enhance the bond between the plastic and the glass window 2, before the plastic is fashioned.

The hole 4 here admittedly lies outside the perimeter of the window 2, so it does not pass through the latter. In other embodiments, one or more holes may however also be provided in the window itself close to the extremity with an adaptation of the positions of the corresponding holes in the support part and in the fashioned part.

The limitation face of the fashioned part 5, situated away from the glass window 2, has the form of a contact face 6 for the support part 3 to which this latter is assembled by using an appropriately high strength adhesive. It is however also possible, as an option, as has already been mentioned hereinabove, to assemble the support part 3 directly, hence without the use of a separate adhesive, to the thermoplastic material of the fashioned part (before it has cured), the thermoplastic plastic (for example a polyurethane or a thermoplastic elastomer) itself then forming the bond.

The contact face 6 has, with the aid of an appropriate device, been oriented in relation to the points P1, P2 and P3 in a mass of plastic deposited, shapelessly at first, by movement and removal of the excess material, in such a manner that its orientation in space depends only on the predetermined points P1, P2 and P3 of the glass window 2, or of the device. In this particular instance, the points P1 and P2 represent the upper sealing face when the pane is in the closed position. The position in space of the contact face 6 is therefore independent of the local curvature of the pane in the region of the support part 3. This fact is illustrated by the representation in broken line of another glass window 20 exhibiting another curvature. Although the curvature of the glass window 20 falls outside the “ideal” curvature of the glass window 2 (grossly exaggerated in the drawing), the upper edge (P2) of the pane and the support part 3 lie every time in the same relative position one to the other. Similarly, the three contact points coincide in the two windows irrespective of their different curvatures. The fashioned part 5 must in consequence be considered to be an adapter (specific to each window).

It can be seen in particular that the angular position of the support part 3 is independent of the end tangent of the lower edge of the pane, or of the orientation of the main faces of the windows 2 or 20 in the region of assembly between the pane and the support part. If, on the contrary, the support part had, according to the state of the art, to be attached directly to the pane, there would then, as a function of the radii of curvature of the latter, be very different angular orientations, which would make it very difficult to correctly press the upper edge of the pane (points P1 and P2) against the seal and which could not be compensated for other than by a very costly mechanical adjustment inside the lift mechanism.

A fashioned/adapter part may also, as is shown in FIG. 2, be disposed in addition on the surface of the glass windows 2 or 20 with concave curvature facing toward the interior of the vehicle. In the present embodiment, the fashioned part S comprises in a single piece the (lower) edge of the windows 2 or 20 and also presses against the extremity region of the interior main face of the windows 2 or 20. Thus another contact face 6′ can be produced, aligned on the predetermined points P1, P2 and P3, which then serves to position an additional support part 3′. Such a disposition has the advantage that relatively high clamping forces can be applied to attach the glass window 2 or 20 because the glass window itself is protected against unacceptable stress by the fashioned part 5.

1-16. (canceled)

17. A method for fabrication of a vehicle drop glass, with a transparent pane, on an extremity of which a support part is to be attached, which cooperates with a drive and/or guide device for heightwise movement of the pane, the method comprising:
orienting and attaching the pane at plural predetermined points of its surface in a device adapted to its shape;
depositing a curable plastic material on the pane with aid of at least one tool in a region of an assembly with the support part and fashioning such, in a fixed position in a space inside the device, into a fashioned part which, after its assembly with the pane, defines a position of the support part in relation to the predetermined points; and
curing the plastic material.

18. The method as claimed in claim 17, wherein the fashioned part is shaped without bonding with the pane and is then assembled to the pane in a same position.

19. The method as claimed in claim 17, wherein the fashioned part is shaped while bonding to the pane.

20. The method as claimed in claim 17, wherein the support part is made of at least one additional part, which is attached to the fashioned part in a predetermined position by at least one contact face fashioned on the fashioned part.

21. The method as claimed in claim 20, wherein the support part including the additional part is used as a portion of a mold used to shape the fashioned part, by pressing the support part for shaping onto a mass of plastic material constituting the fashioned part.

22. The method as claimed in claim 20, wherein the support part constituting the additional part is used as a portion of a mold used to shape the fashioned part, by first attaching it in a predetermined spatial position inside the device and by subsequently filling with plastic mass an intermediate space that exists in the region of assembly between the support part put in place and a surface of the pane.

23. The method as claimed in claim 17, wherein the support part is assembled to the fashioned part by bonding, either with an adhesive deposited in addition or by direct adhesion between the fashioned part and the support part.

24. The method as claimed in claim 17, wherein the support part is assembled to the fashioned part with aid of a mechanical assembly by clamping and/or interlocking.

25. The method as claimed in claim 17, wherein the fashioned part itself forms at least one portion of the support part.

26. A vehicle drop glass comprising:
a transparent pane on a bottom extremity of which is attached a support part that cooperates with a drive and/or guide device,
wherein a spatial position of the fixed support part is oriented in relation to the window with aid of a fashioned part formed on the pane, at plural predetermined points, at least two of which are situated on an edge of closure of the pane.

27. The vehicle window pane as claimed in claim 26, wherein the fashioned part presents a contact face oriented in relation to plural predetermined points of its surface, for positioning of the support part.

28. The vehicle window pane as claimed in claim 26, wherein two of the predetermined points are in a region of an upper edge of the pane cooperating with a seal and another point is disposed close to the fashioned part put in place.

29. The vehicle window pane as claimed in claim 26, wherein the fashioned part includes a curable thermoplastic or plastic material.

30. The vehicle window pane as claimed in claim 26, wherein, in a region of the support part, oriented contact faces of the fashioned part are provided, on two main opposing faces of the window.

31. The vehicle window pane as claimed in claim 26, wherein the support part is provided with a threaded hole or with a threaded stud for assembly to a drive or guide device.

32. The vehicle window pane as claimed in claim 26, wherein the pane, the contact face, and where necessary the support part are respectively provided with at least one recess, the recesses being aligned one with another and having passing through them a bolt or a screw for assembly with a drive or guide device.
